(19) United States
(12) Patent Application Publication
(10) Pub. No.: US 2015/0149995 A1
(43) Pub. Date: May 28, 2015

(54) IMPLEMENTING DYNAMIC VIRTUALIZATION OF AN SRIOV CAPABLE SAS ADAPTER

(71) Applicant: International Business Machines Corporation, Armonk, NY (US)

(72) Inventors: Jesse P. Arroyo, Rochester, MN (US); Brian E. Bakke, Rochester, MN (US); Ellen M. Bauman, Rochester, MN (US); Robert Galbraith, Rochester, MN (US); Charles S. Graham, Rochester, MN (US); Timothy J. Schimke, Stewartville, MN (US)

(73) Assignee: International Business Machines Corporation, Armonk, NY (US)

(21) Appl. No.: 14/087,330

(22) Filed: Nov. 22, 2013

(51) Int. Cl. G06F 9/44; G06F 9/455

(52) U.S. Cl. CPC G06F 9/4411; G06F 9/45533; G06F 2009/45579
USPC 718/1

(57) ABSTRACT

A method, system and computer program product are provided for implementing dynamic virtualization of a Single Root Input/Output Virtualization (SRIOV) capable Serial Attached SCSI (SAS) adapter. The SRIOV SAS adapter includes a plurality of virtual functions (VFs). Each individual Host Bus Adapter (HBA) resource is enabled to be explicitly assigned to a virtual function (VF); and each VF being enabled to be assigned to a system partition. Multiple VFs are enabled to be assigned to a single system partition.

### FIELD OF THE INVENTION

The present invention relates generally to the data processing field, and more particularly, relates to a method, system and computer program product for implementing dynamic virtualization of a Single Root Input/Output Virtualization (SRIOV) capable Serial Attached Small-Computer System-Interface (SAS) adapter.

### DESCRIPTION OF THE RELATED ART

A low cost enterprise class storage environment is characterized by the use of Host Bus Adapters (HBAs) to directly attach Storage devices using the Serial Attached SCSI (SAS) or Serial ATA (Advanced Technology Attachment) (SATA) protocols. As technology has become denser, the number of storage devices that can be attached to a single HBA has grown from single digits to the order of hundreds.

At the same time the physical size of Host System Central Electronics Complexes (CECs) has decreased, the processor horsepower has increased, and the number of System Bus slots available for HBAs has been reduced. This increase in compute density has spawned the growth of system partitioning in which multiple system images run independently on the same physical system without knowing about each other.

Traditional HBAs have provided Application Programming Interfaces (APIs), or views seen by a System Image's I/O Driver Software Stack, that show a single, monolithic view of the HBA and all logical and physical resources associated with that HBA. This necessitates a minimum of one physical HBA for each System Image.

Single root input/output (10) virtualization (SRIOV) is a PCI standard, providing an adapter technology building block for I/O virtualization within the PCI-Express (PCIe) industry. Single root input/output (IO) virtualization (SRIOV) was developed by the industry PCI Special Interest Group as the basis of splitting a physical HBA into multiple virtual HBAs. The PCI technology only deals with describing the host bus level access to one Physical Function (PF) and multiple Virtual Functions (VFs). It does not deal with any HBA APIs or Models and as such is a stepping stone, but not a complete solution. This SRIOV technology is an emerging technology in this storage space. The SAS architecture does not have any explicit virtualization models.

A need exists for an effective mechanism to enable dynamic virtualization of a Single Root Input/Output Virtualization (SRIOV) capable Serial Attached Small-Computer System-Interface (SAS) adapter. It is desirable that such mechanism allows the single adapter to be shared by multiple System Images. It is desirable that such mechanism enables relatively the same performance level for each Virtual Function that a dedicated HBA would have for its single host. It is desirable that such mechanism preserves the existing APIs to the System Image's I/O Driver Software Stacks to avoid the development cost of rewriting numerous Driver stacks for different operating systems. It is desirable that such mechanism provides resource/function isolation and hiding on a per Virtual Function basis.

### SUMMARY OF THE INVENTION

Principal aspects of the present invention are to provide a method, system and computer program product for implementing dynamic virtualization of a Single Root Input/Output Virtualization (SRIOV) capable Serial Attached SCSI (SAS) adapter. Other important aspects of the present invention are to provide such method, system and computer program product substantially without negative effects and that overcome many of the disadvantages of prior art arrangements.

In brief, a method, system and computer program product are provided for implementing dynamic virtualization of a Single Root Input/Output Virtualization (SRIOV) capable Serial Attached SCSI (SAS) adapter. The SRIOV SAS adapter includes a plurality of virtual functions (VFs). Each individual Host Bus Adapter (HBA) resource is enabled to be explicitly assigned to a virtual function (VF); and each VF being enabled to be assigned to a system partition. Multiple VFs are enabled to be assigned to a single system partition.

In accordance with features of the invention, system partition read/write performance for each VF is substantially equivalent to performance achieved for a dedicated HBA.

In accordance with features of the invention, a single physical HBA resource optionally is subdivided into multiple virtual resources, then each of the subdivided multiple virtual resources optionally is assigned to a different system partition.

In accordance with features of the invention, configuration and management Application Programming Interfaces (APIs) are disabled on the virtual functions (VFs), and only are enabled on a Physical Function of the SRIOV SAS adapter.

In accordance with features of the invention, the assignment of Host Bus Adapter (HBA) resources to VFs is determined by a Resource Manager and the assignments are communicated from the Resource Manager to the SRIOV SAS adapter using the Physical Function of the SRIOV SAS adapter.

In accordance with features of the invention, commands to Read or Write data are sent directly from the system partition to the HBA resource via the respective VF without any intermediary.

In accordance with features of the invention, a host or system partition is prevented from issuing any commands to the HBA resource that could adversely affect another host partition.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A, 1B, and FIG. 2 illustrate a respective example system for implementing dynamic virtualization of a Single Root Input/Output Virtualization (SRIOV) capable Serial Attached SCSI (SAS) adapter in accordance with the preferred embodiment;

FIGS. 3, and 4 illustrate example operational features for implementing dynamic virtualization of the Single Root Input/Output Virtualization (SRIOV) capable Serial Attached SCSI (SAS) adapter of FIGS. 1A, 1B, and FIG. 2 in accordance with preferred embodiments; and

FIG. 5 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method, system and computer program product are provided for implementing dynamic virtualization of a Single Root Input/Output Virtualization (SRIOV) capable Serial Attached SCSI (SAS) adapter. The SRIOV SAS adapter includes a plurality of virtual functions (VFs). Each individual Host Bus Adapter (HBA) resource is explicitly assigned to a virtual function (VF); and each VF being assigned to a system partition. Multiple VFs optionally are assigned to a single system partition. A system or host partition is prevented from issuing any commands to the SRIOV SAS adapter that could adversely affect another host partition.

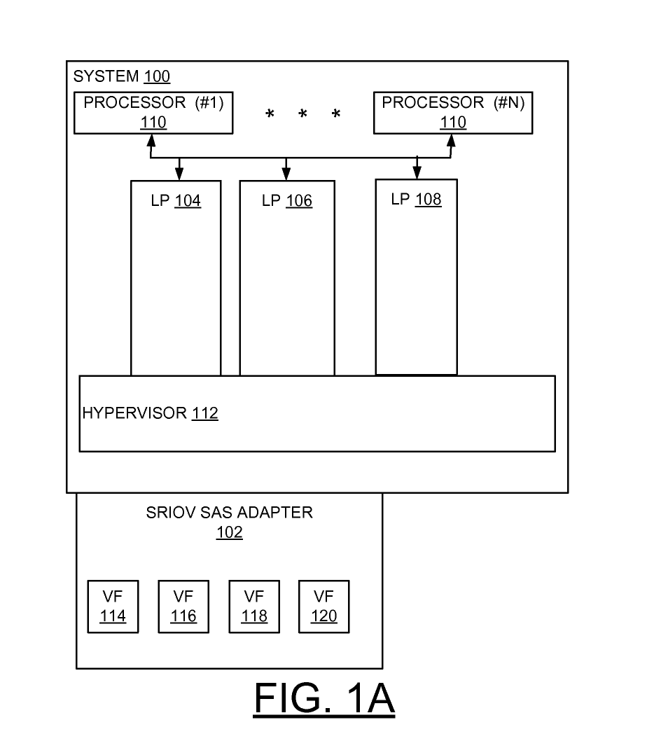

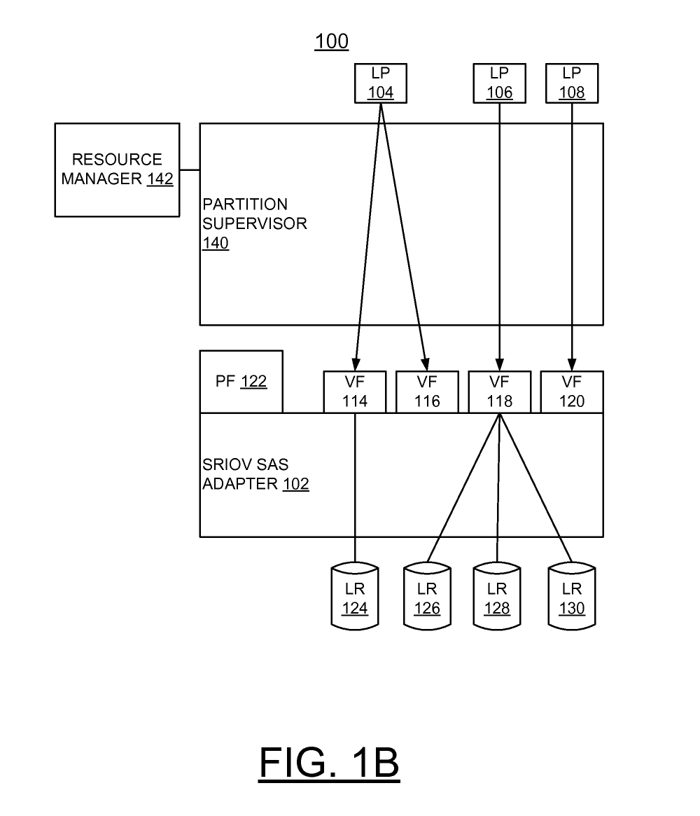

Having reference now to the drawings, in FIGS. 1A and 1B, there is shown an example computer system generally designated by the reference character 100 for implementing dynamic virtualization of a Single Root Input/Output Virtualization (SRIOV) capable Serial Attached SCSI (SAS) adapter 102 in accordance with a preferred embodiment.

Computer system 100 is partitioned into a number of logical partitions (LPs) 104, 106, 108. Computer system 100 includes a plurality of processors 1-N, 110, or central processor units (CPUs) 110 and a hypervisor 112. Each logical partition LPs 104, 106, 108 represents a division of resources in the system and operates as an independent logical system. An example of logical partitions 104, 106, 108 is the partitioning of the multiprocessor computer system 100 into multiple independent servers, for example, each with one or more processors, main storage, and I/O devices.

Computer system 100 includes the Single Root Input/Output Virtualization (SRIOV) SAS adapter 102. The SRIOV SAS adapter includes a plurality of virtual functions (VFs) 114, 116, 118, 120.

The SRIOV SAS adapter 102 has an I/O adapter virtualization architecture that allows the single SRIOV adapter to be concurrently shared across many different logical partitions LPs 104, 106, 108.

Referring to FIG. 1B, additional example features of the computer system 100 are illustrated. The SRIOV SAS adapter 102 includes a physical function (PF) 122, for example used for configuration and management of the set of virtual functions VFs 114, 116, 118, 120. Configuration and management Application Programming Interfaces (APIs) are disabled on the virtual functions VFs 114, 116, 118, 120, and only are enabled on the physical function PF 122 in accordance with the preferred embodiment.

As shown FIG. 1B, SRIOV SAS adapter 102 includes a plurality of Host Bus Adapter (HBA) resources or logical resources (LR) 124, 126, 128, 130 associated with the adapter 102, such as directly attached storage devices using the Serial Attached SCSI (SAS) protocol. The single SRIOV SAS adapter 102 is shared by multiple system partitions or LPs 104, 106, 108.

In accordance with features of the invention, each individual HBA resource or each of the LRs 124, 126 128, 130, for example, a RAID protected volume, can be explicitly assigned to a Virtual Function of the illustrated virtual functions VFs 114, 116, 118, 120. Multiple HBA resources or one or more LRs 124, 126 128, 130 can be explicitly assigned to a single Virtual Function of the illustrated virtual functions VFs 114, 116, 118, 120. Each of the illustrated virtual functions VFs 114, 116, 118, 120 can be assigned to a system partition of the illustrated LPs 104, 106, 108. Multiple virtual functions VFs 114, 116, 118, 120 can be assigned to a single system partition of the illustrated LPs 104, 106, 108.

As shown FIG. 1B, the logical partition LP 104 is assigned to virtual functions VFs 114, 116 with the respective logical partitions LPs 106, 108 assigned to respective virtual functions VFs 118, 120. Computer system includes a partition supervisor 140 and a resource manager 142 in accordance with preferred embodiments.

Computer system 100 is shown in simplified form sufficient for understanding the present invention. The illustrated computer system 100 is not intended to imply architectural or functional limitations. The present invention can be used with various hardware implementations and systems and various other internal hardware devices.

As shown FIG. 1B, the single SRIOV SAS adapter 102 contains numerous logical resources LRs 124, 126 128, 130, for example, a RAID protected volume. Each of the LRs 124, 126 128, 130 must be assigned to one or more virtual functions VFs 114, 116, 118, 120 before the LR can be accessed. Only the VF of the virtual functions VFs 114, 116, 118, 120 that is assigned a particular LR of logical resources LRs 124, 126 128, 130 can access the particular LR. Each of virtual functions VFs 114, 116, 118, 120 may be assigned zero LRs, such as VF 120, or one, such as VF 114, or many, such as VF 118. Each of the virtual functions VFs 114, 116, 118, 120 may be assigned to the logical partitions LPs 104, 106, 108. More than one of the virtual functions VFs 114, 116, 118, 120 may be assigned to the same LP, such as LP 104. Note that the single SRIOV SAS adapter 102 does not have cognizance of how many logical partitions LPs 104, 106, 108 exist.

Initially no logical resources LRs 124, 126 128, 130 are assigned to any of the virtual functions VFs 114, 116, 118, 120. Assignment of LRs to VFs is determined by the resource manager 142 in accordance with preferred embodiments. These assignments are communicated from the resource manager 142 to the SRIOV SAS adapter 102 using the physical function PF 122. Note that this communication method is in-band and does not require a separate, management console physical port. This is an improvement over most if not all of the known Storage Area Network (SAN) arrangements that require a separate Ethernet port for a conventional management console.

The partition supervisor 140 initially discovers the SRIOV SAS adapter 102 and queries the adapter through the PF 122 to determine the capabilities, such as number of VFs supported. The partition supervisor 140 communicates this information to the resource manager 142. Information about devices connected to the SRIOV SAS adapter 102 and the LRs are also communicated via this same in-band path. The resource manager 142 then provides information via a User Interface (UI), such as a GUI, CLI, API or otherwise.

In accordance with features of the invention, in a preferred implementation of system 100 the resource manager 142 would run an assignment process every time the adapter 102 is reset and the resource manager 142 persistently remembers the assignments. This feature of the invention eliminates any Host Assignment policy from the SRIOV SAS adapter 102 and centralizes it in the resource manager 142. Alternatively, the SRIOV SAS adapter 102 could be implemented to persistently remember the assignments; however, this has the drawback of potentially being out of sync with the system 100 due to any maintenance or reconfiguration actions.

A user or other entity can then manage the logical resources LRs 124, 126 128, 130 and assign LRs to VFs of the virtual functions VFs 114, 116, 118, 120 via the resource manager 142. The assignments configuration is communicated to the partition supervisor 140 then to the SRIOV SAS adapter 102 via the physical function PF 122. This can be accomplished via a mechanism similar to that used to assign physical adapters to the LPs today. For example, the resources assigned are storage resources, such as a volume set, instead of a physical adapter but the information about them is persisted in a similar fashion. For example, the WWID (world wide unique ID) of the volume set is used as identifier to persistently and consistently identify the specific storage resources.

In accordance with features of the invention, in a preferred implementation of system 100 the APIs provided by a dedicated HBA are split. The configuration and management APIs are only enabled on the physical function PF 122. Read/Write APIs are enabled on the PF until the resource is assigned to a VF by the Resource Manager 142. Read/Write APIs are enabled only on respective VFs 114, 116, 118, 120 after they are assigned to the VFs. Query APIs to the PF 122 return information about the entire SRIOV SAS adapter 102. Query APIs to the VF return only the information about LRs assigned to the VF. Normal HBA and physical device maintenance actions are not available to the VF and are only made available to the PF, hiding isolation which prevents one VF from corrupting the PF or any other VF.

An LP, such as logical partitions LPs 104, 106, 108, continues to discover the logical resources LRs 124, 126 128, 130 assigned to it by using an existing Query API to the respective one or more of the virtual functions VFs 114, 116, 118, 120 it owns. Once a particular LP of logical partitions LPs 104, 106, 108 has discovered its logical resources LRs 124, 126 128, 130, commands to Read or Write data are sent directly from the LP to the LR via the respective virtual functions VFs 114, 116, 118, 120 without any intermediary. Data is transferred directly to/from the LR/VF from/to the LP buffers without any intermediary. This allows Read/Write performance equivalent to a conventional dedicated HBA. This also allows the investment in existing device drivers to be preserved, as the interfaces are the same.

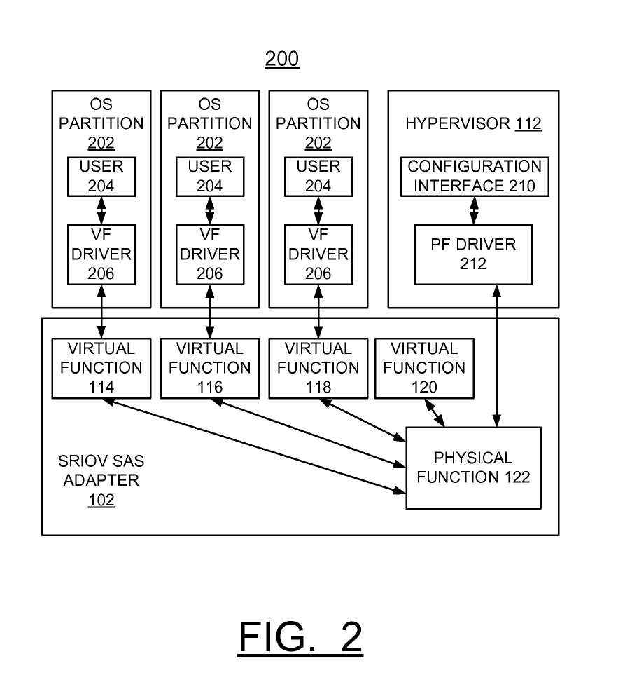

Referring to FIG. 2, there is shown another example system generally designated by the reference character 200 for implementing dynamic virtualization of an adapter, such as the Single Root Input/Output Virtualization (SRIOV) capable Serial Attached SCSI (SAS) adapter 102 in accordance with preferred embodiments.

System 200 includes a plurality of operating system (OS) partitions 202, each OS partition 202 including a respective user 204 and a VF driver 206 associated with a respective virtual function VR of respective VFs 114, 116, 118, 120. System 200 includes a hypervisor 112 or other virtualization intermediary, including a configuration interface 210 and a physical function driver 212 associated with the physical function PF 122 of the SRIOV SAS adapter 102. For example, as shown in FIG. 2, the hypervisor 112 is used for persistently storing correlation data such that storage resources can be associated with a specific OS partition 202. The storage resources naturally include volume sets, but also include generic SCSI and ATA resources. This data is held completely within the hypervisor 112 and not persisted on the adapter 102 itself. When activating a partition 202, the hypervisor 112 first assigns the associated resources with an arbitrary unused VF of respective VFs 114, 116, 118, 120 in the adapter 102 using the PF driver 212. The specific VF used is unimportant, and can change from activation to activation. When the OS partition 202 is activated, the VF of respective VFs 114, 116, 118, 120 is assigned as a partition resource, and the adapter 102 exposes the limited set of resources appropriately to that partition.

System 200 is shown in simplified form sufficient for understanding the present invention. The illustrated system 200 is not intended to imply architectural or functional limitations. The present invention can be used with various hardware implementations and systems and various other internal hardware devices.

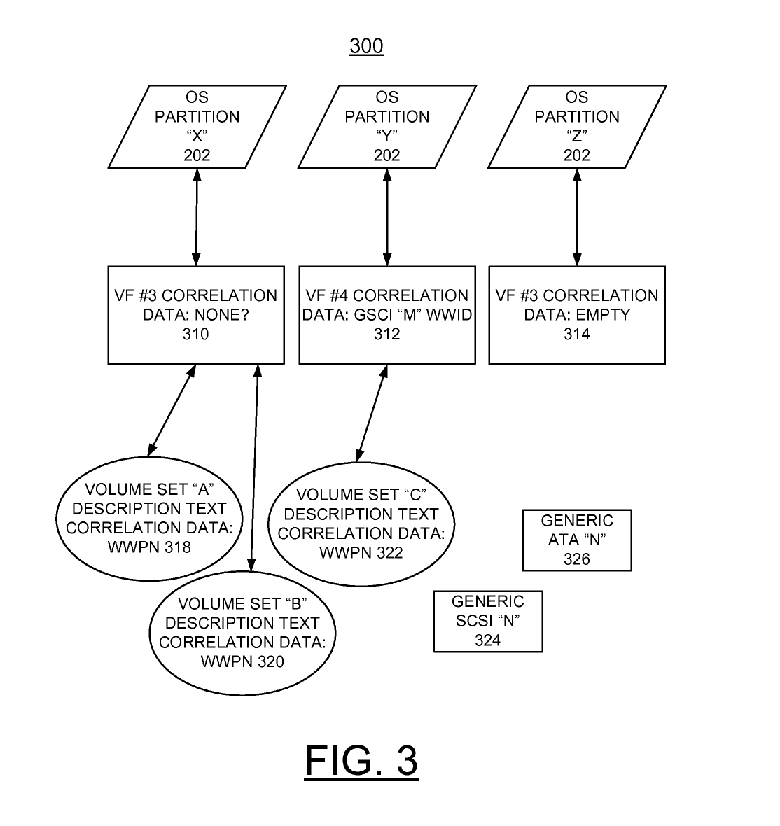

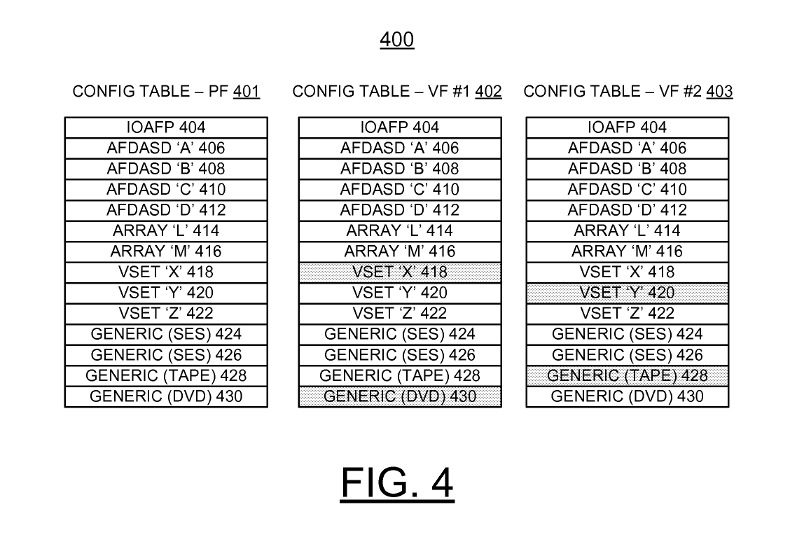

Referring to FIGS. 3 and 4, example operational features respectively generally designated by the reference character 300, 400 are shown for implementing dynamic virtualization of the Single Root Input/Output Virtualization (SRIOV) capable Serial Attached SCSI (SAS) adapter 102 of FIGS. 1A, 1B, and FIG. 2 in accordance with preferred embodiments.

In FIG. 3, OS partitions, X, Y, Z, 202 are shown respectively with VF #3, checking for correlation data “None” at block 310, VF #4, checking for correlation data “GSCI M WWID” at block 312, and VF #5, checking for correlation data “empty” at block 310. As shown in FIG. 2, the hypervisor 112 uses persistent correlation data which links a particular set of SRIOV SAS adapter 102 resources to respective OS partitions, X, Y, Z, 202, as shown in FIG. 3. With volume set resources it is possible for correlation data, for example, a World Wide Port Number (WWPN), to be stored by hypervisor 112 in the description text, which is maintained by the adapter 102 in metadata kept on storage devices, such as shown at block 318 volume set “A” description Text Correlation Data: WWPN, at block 320 volume set “B” description Text Correlation Data: WWPN, and at block 322 volume set “C” description Text Correlation Data: WWPN. However, for Generic SCSI and Generic ATA resources respectively shown at blocks 324 and 236, there is no metadata kept on the storage devices, and any correlation data stored by the hypervisor 208 must be kept elsewhere, and preferable not the SRIOV SAS adapter 102 since adapters can be replaced.

Referring now to FIG. 4, an example SRIOV SAS adapter 102 configuration table generally designated by the reference character 400 is illustrated. A configuration table is returned as the response to an API Configuration Query command. Configuration table PF 401 is returned on API Query Configuration command to the PF. Configuration table—VF #1 402 is returned on API Query Configuration command to the VF #1. Configuration table—VF #2 403 is returned on API Query Configuration command to the VF #2, each with example SRIOV SAS adapter 102 resources, as shown. All SRIOV SAS adapter 102 resources are visible to the PF 122. For example, a VSET ‘X’ 418 and a Generic DVD 430 are assigned to VF #1, and a VSET ‘Y 420’ and a Generic tape 428 are assigned to VF #2. Note that all items in the Configuration table PF 401 are reported via the API; while in the Configuration table—VF #1 402 and Configuration table—VF #2 403, only the assigned SRIOV SAS adapter 102 resources shown with shading are reported via the API.

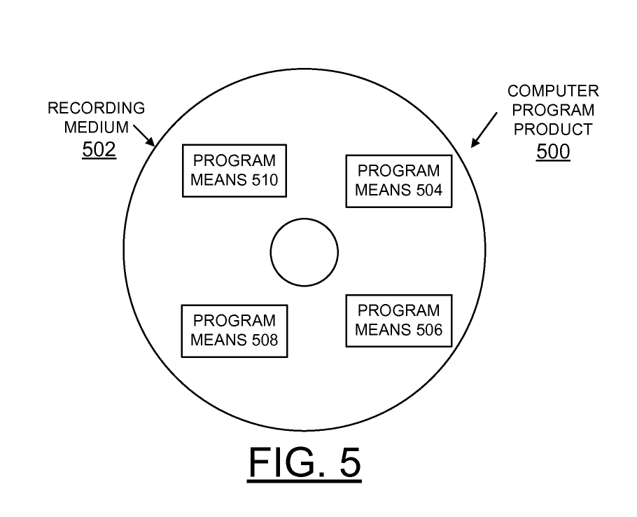

Referring now to FIG. 5, an article of manufacture or a computer program product 500 of the invention is illustrated. The computer program product 500 is tangibly embodied on a non-transitory computer readable storage medium that includes a recording medium 502, such as, a floppy disk, a high capacity read only memory in the form of an optically read compact disk or CD-ROM, a tape, or another similar computer program product. Recording medium 502 stores program means 504, 506, 508, and 510 on the medium 502 for carrying out the methods for implementing dynamic virtualization of the Single Root Input/Output Virtualization (SRIOV) capable Serial Attached SCSI (SAS) adapter 102 of preferred embodiments in the system 100 of FIGS. 1A and 1B, or system 200 of FIG. 2.

A sequence of program instructions or a logical assembly of one or more interrelated modules defined by the recorded program means 505, 506, 508, and 510, direct the computer system 500 for implementing dynamic virtualization for an I/O adapter, such as a Single Root Input/Output Virtualization (SRIOV) adapter of a preferred embodiment.

While the present invention has been described with reference to the details of the embodiments of the invention shown in the drawing, these details are not intended to limit the scope of the invention as claimed in the appended claims.

What is claimed is:

1. A method for implementing dynamic virtualization of a Single Root Input/Output Virtualization (SRIOV) capable Serial Attached SCSI (SAS) adapter comprising:
providing the SRIOV SAS adapter with a plurality of virtual functions (VFs) for sharing by multiple system partitions;
enabling each individual Host Bus Adapter (HBA) resource to be assigned to a virtual function (VF);
enabling each VF to be assigned to one or more system partitions; and
enabling multiple VFs to be assigned to a single system partition.

2. The method as recited in claim 1, includes providing a physical function with the Single Root Input/Output Virtualization (SRIOV) SAS adapter.

3. The method as recited in claim 2, includes enabling configuration and management Application Programming Interfaces (APIs) on the physical function.

4. The method as recited in claim 1, includes disabling configuration and management Application Programming Interfaces (APIs) on the virtual functions (VFs).

5. The method as recited in claim 1, includes assigning one or more HBA resources to a given virtual function; assigning the given virtual function to a respective system partition; and enabling respective system partition read/write commands from the respective system partition sent to the respective assigned HBA resource.

6. The method as recited in claim 1, includes directly sending commands from the respective system partition to the respective assigned HBA resource via the respective given virtual function for providing enhanced system partition read/write performance for each respective virtual function.

7. The method as recited in claim 1, includes enabling a single, Physical HBA resource to be subdivided into multiple virtual resources; and enabling each of the multiple virtual resources to be assigned to a different system partition.

8. The method as recited in claim 1, includes a hypervisor for persistently storing correlation data associating HBA resources with a specific system partition.

9. The method as recited in claim 8, includes providing a physical function (PF) driver and a configuration interface with said hypervisor.

10. The method as recited in claim 9, includes said hypervisor first assigning respective associated HBA resources with an arbitrary unused VF in the SRIOV SAS adapter using said physical function (PF) driver.

11. The method as recited in claim 1, includes enabling Read/Write Application Programming Interfaces (APIs) only on respective virtual functions (VFs).

12. A system for implementing dynamic virtualization of a Single Root Input/Output Virtualization (SRIOV) capable Serial Attached SCSI (SAS) adapter comprising:
the SRIOV SAS adapter comprising a plurality of virtual functions (VFs) for sharing by multiple system partitions, each VF enabled to be assigned to one or more system partitions and multiple VFs enabled to be assigned to a single system partition; a physical function, and a plurality of Host Bus Adapter (HBA) resources to be assigned to a respective virtual function (VF);
a plurality of said system partitions; each said system partition including one or more processors; and a virtual function (VF) driver;
a resource manager and a partition supervisor for implementing dynamic virtualization of the SRIOV SAS adapter; said resource manager and said partition supervisor including control code tangibly embodied in a non-transitory machine readable medium;
said resource manager assigning HBA resources to said virtual functions (VFs) and persistently remembering the assignments and communicating the assignments to said partition supervisor.

13. The system as recited in claim 12, wherein said partition supervisor communicates the assignments to said system partitions.

14. The system as recited in claim 12, wherein said resource manager communicates the assignments the SRIOV SAS adapter via said physical function.

15. The system as recited in claim 12, includes configuration and management Application Programming Interfaces (APIs) being enabled on the physical function of the SRIOV SAS adapter.

16. The system as recited in claim 13, wherein said configuration and management Application Programming Interfaces (APIs) being disabled on said virtual functions (VFs) of the SRIOV SAS adapter.

17. The system as recited in claim 12, includes Read/Write Application Programming Interfaces (APIs) being enabled on only on respective virtual functions (VFs) of the SRIOV SAS adapter.

18. The system as recited in claim 12, wherein said resource manager and said partition supervisor include a hypervisor.

19. The system as recited in claim 18, wherein said hypervisor includes a physical function (PF) driver and a configuration interface.

20. The system as recited in claim 18, includes said hypervisor persistently storing correlation data associating HBA resources with a specific system partition.
